(19) United States
(12) Patent Application Publication
(10) Pub. No.: US 2007/0198389 A1
(43) Pub. Date: Aug. 23, 2007

(54) Locality based index

(75) Inventors: Brian Scott Orloske, Houlton, WI (US); Eric John Orloske, St. Paul, MN (US)

Correspondence Address: MERCHANT & GOULD PC, P.O. BOX 2903, MINNEAPOLIS, MN, 55402-0903, US

(73) Assignee: U.S. Capital & Trust, Inc.

(21) Appl. No.: 11/784,439

(22) Filed: Apr. 6, 2007

Related U.S. Application Data
(63) Continuation-in-part of application No. 11/269,404, filed on Nov. 7, 2005.
(60) Provisional application No. 60/835,971, filed on Aug. 7, 2006.
(60) Provisional application No. 60/835,970, filed on Aug. 7, 2006.

(51) Int. Cl. G06Q 40/00

(52) U.S. Cl. 705/36 R

(57) ABSTRACT

An inventive index includes securities from one or more select companies headquartered in at least two geographic or political localities within a select geographic region. For example, the index can include the ten largest publicly traded corporations by market capitalization within each of the fifty states of the United States of America. The companies within each locality are ranked and the top companies are chosen based on selection criteria. Investment products can be formed based on the inventive index.

### TECHNICAL FIELD

The invention relates to an index on which investment products can be based, and more particularly to an index composed of securities chosen based on locality and other selection criteria.

### BACKGROUND

An index is generally a list of securities (e.g., stocks, bonds, and/or commodities) or companies within a securities market. Typically, an index functions as a statistical measure of change in a securities market. An index also can track the ups and downs of the securities market by reflecting market prices and the number of shares outstanding for the companies in the index. Some investment products can be created based on indexes. Examples of investment products include exchange traded funds, index funds, and mutual funds.

For example, an Exchange Traded Fund (“ETF”) is a security that includes multiple stocks, similar to a mutual fund, but trades on a stock exchange like an ordinary stock. In general, an ETF will primarily invest in the securities of companies that are included in a selected index. An ETF will invest in either all of the securities or a representative sample of the securities included in the index. For example, one type of ETF, known as Spiders (or “SPDRs”), invests in all of the stocks contained in the S&P 500 Composite Stock Price Index.

### SUMMARY

An index formed according to an embodiment of the disclosure includes securities from one or more select companies headquartered in at least two geographic or political localities within a select geographic region. The companies within each locality are ranked and the top companies are chosen based on selection criteria.

A method of forming the index according to an embodiment of the disclosure generally includes obtaining securities (e.g., stocks, bonds, etc.) of at least one company in each of multiple geographic or political localities. The index is passively managed by regularly adding stocks to and deleting securities from the index to conform to periodic changes in the identity of the select companies.

An example method of selecting the companies in each of the localities according to an embodiment of the disclosure includes obtaining a listing of companies in a locality; sorting the companies into a hierarchy by selection criteria (e.g., market capitalization); and selecting a predetermined number of companies ranked at the top of the hierarchy. This method is performed for each of the geographic localities to identify at least one company from each locality for inclusion in the index.

In accordance with an embodiment, a method for obtaining a listing of companies in a locality includes obtaining a listing of companies for a region and filtering the listing to include only companies headquartered in a select locality within the region.

In an example embodiment, the index is created by populating a database with identities of companies, the locality in which each company is headquartered, and desired information about each company (e.g., market capitalization). Creating the index also includes analyzing the information in the database to organize the companies by locality and to rank the companies within each locality based on the desired information. A predetermined number of top ranked companies from each locality are selected and combined to form the index.

In an example embodiment, the geographic localities are states within the United States of America.

In another example embodiment, the geographic localities are countries within a select continent.

Examples of selection criteria include market capitalization, price-to-earnings ratio, total dividends paid out, and total earnings.

An exchange traded fund (ETF) can be formed by obtaining securities from each company in the index. The ETF can be divided into shares. Each share represents an undivided ownership interest in the ETF.

A method for trading an ETF according to an embodiment of the disclosure includes creating an index, forming an ETF based on the index, passively managing the index, and trading the shares of the ETF on a security exchange.

### BRIEF DESCRIPTION OF THE DRAWINGS

FIG. 1 is a schematic representation of methods and systems for compiling and dividing assets according to one embodiment of the present disclosure;

FIG. 2 is a schematic diagram illustrating an exemplary composition of an index according to one example embodiment of the present disclosure;

FIG. 3 is an operational flow for a creation process for creating an index according to one example embodiment of the present disclosure;

FIG. 4 illustrates a first arrangement of information stored within a database in accordance with one example embodiment of the present disclosure;

FIG. 5 illustrates a second arrangement of information stored within the database of FIG. 4 in accordance with one example embodiment of the present disclosure;

FIG. 6 illustrates a third arrangement of information stored within the database of FIG. 4 in accordance with one example embodiment of the present disclosure;

FIG. 7 illustrates a fourth arrangement of information stored within the database of FIG. 4 in accordance with one example embodiment of the present disclosure;

FIG. 8 illustrates the composition of an index formed using the creation process of FIG. 3;

FIG. 9 is an operational flow for a process for creating an investment product in accordance with one example embodiment of the present disclosure; and

FIG. 10 is a schematic representation of a computing system that may be used to implement aspects of the present disclosure.

### DETAILED DESCRIPTION

In general, the present disclosure relates to an index on which investment products (e.g., index mutual funds, exchange traded funds, index portfolios, index futures, and options) can be based. Preferably, the index lists components reflecting the top companies or corporations within different geographic or political locations. For example, the index can reflect the top companies in different localities within a given geographic region. The top companies within each locality are chosen according to a set of selection criteria.

An index formed according to the principles of the disclosure includes securities from one or more select companies. Each of the companies is associated with one of at least two geographic or political localities within a geographic region. In some example embodiments, the geographic localities are countries within a select continent. In some such embodiments, the index includes companies headquartered in each country on a given continent. In other such embodiments, the index includes select countries meeting threshold requirements within a given continent.

In other example embodiments, the geographic localities are states within the United States of America. In such an embodiment, the index includes corporations that are associated with one of the states and that meet selection criteria. For example, in an embodiment, the index includes the top ten companies in each state having the largest market capitalization. In another embodiment, the index includes the top two companies in each state having the highest price-to-earnings ratio.

A method of forming the index according to an embodiment of the disclosure generally includes obtaining securities of at least one company in each of multiple geographic or political localities. Securities can be chosen for inclusion in the index based on selection criteria. Some non-limiting examples of selection criteria include total market capitalization, price-to-earnings ratio, total dividends paid out, and total earnings generated. Securities of the top companies within each locality are chosen based on the selection criteria. These securities are combined as components in the index.

The method also can include excluding securities based on predetermined eligibility criteria. The securities of some companies can be excluded from the index if eligibility requirements are not met. For example, some non-limiting examples of securities that can be excluded from the index, if desired, include closed ended funds, securities of holding companies, tracking stocks, securities of limited partnerships, securities of master limited partnerships, investment vehicles, exchange-traded funds, ADR, ADS, MLP IT units, and royalty trusts.

Generally, the index is passively managed by regularly adding stocks to and deleting securities from the index to conform to periodic changes in the identity of the select companies. For example, when a constituent within the index is no longer one of the top companies within a given locality based on the selection criteria, then the constituent can be deleted. Typically, a new constituent based within the same locality is substituted for the deleted constituent. In addition, companies involved in mergers, acquisitions, or significant restructuring resulting in a drop in rank based on the selection criteria can be deleted and/or replaced.

In general, the amount by which each component affects the rate of return of the index is determined by the weight of each component. In a preferred embodiment, the index is calculated on an equal-weight basis. In other embodiments, however, the components within the index can have differing weights. For example, in an embodiment, the index can be calculated based on a market capitalization weight with no float. In another example embodiment, the index can be market capitalization weighted with a float.

The index can be rebalanced periodically to alter the weight factor applied to each component of the index, if necessary. For example, the weight factor for each component may need to be changed to reflect a lack of eligible companies from a given locality. In different embodiments, the index can be rebalanced quarterly, annually, monthly, daily, or at any desired time.

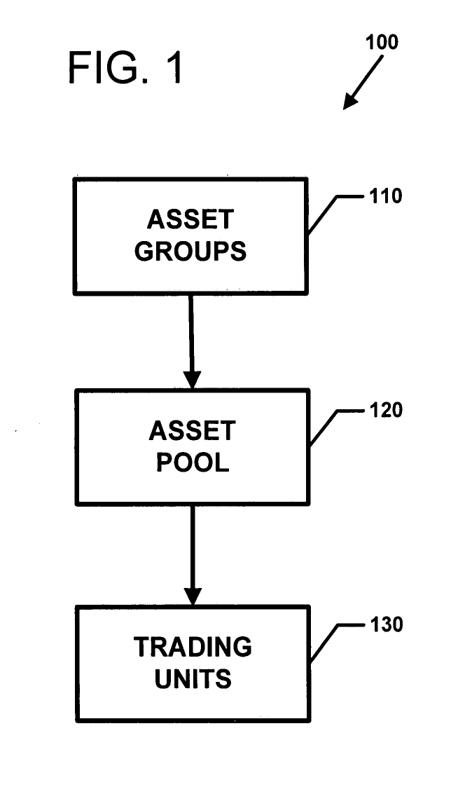

Referring now to the figures, FIG. 1 illustrates a schematic representation of methods and systems 100 for trading a portion of an asset pool 120 (e.g., an ETF) arranged according to an index. Preferably, the components of the asset groups 110 are equally weighted within the indexed asset pool 120. In other embodiments, however, components of a first asset group 110 can be weighted differently than components of a second asset group 110. In still other embodiments, the components of a single asset group 110 can be weighted differently.

The asset pool 120 is then divided into trading units 130. In some example embodiments, the trading units 130 represent equal, undivided ownership interests in the asset pool 120. Generally, each trading unit 130 can be bought and sold individually or in groups. In some embodiments, the trading units 130 can be bought and sold via a public exchange such as a stock exchange.

In general, the assets included in an asset group 110 share common properties. In some embodiments, the asset groups 110 can each include a listing of select securities meeting predetermined selection criteria. For example, in an embodiment, all of the assets in a first asset group 110 can include securities of companies headquartered or domiciled within the same geographic location. In another example embodiment, all of the assets in an asset group 110 correspond to companies having similar financial situations. In other embodiments, the groups of assets 110 can include indexes, mutual funds, stock portfolios, and other such groupings of assets.

In some example embodiments, all of the trading units 130 include substantially the same composition of assets in substantially the same proportions. In some other embodiments, two or more groups of trading units 130 are formed from the asset pool 120 using filter criteria, each group having similar assets in similar proportions.

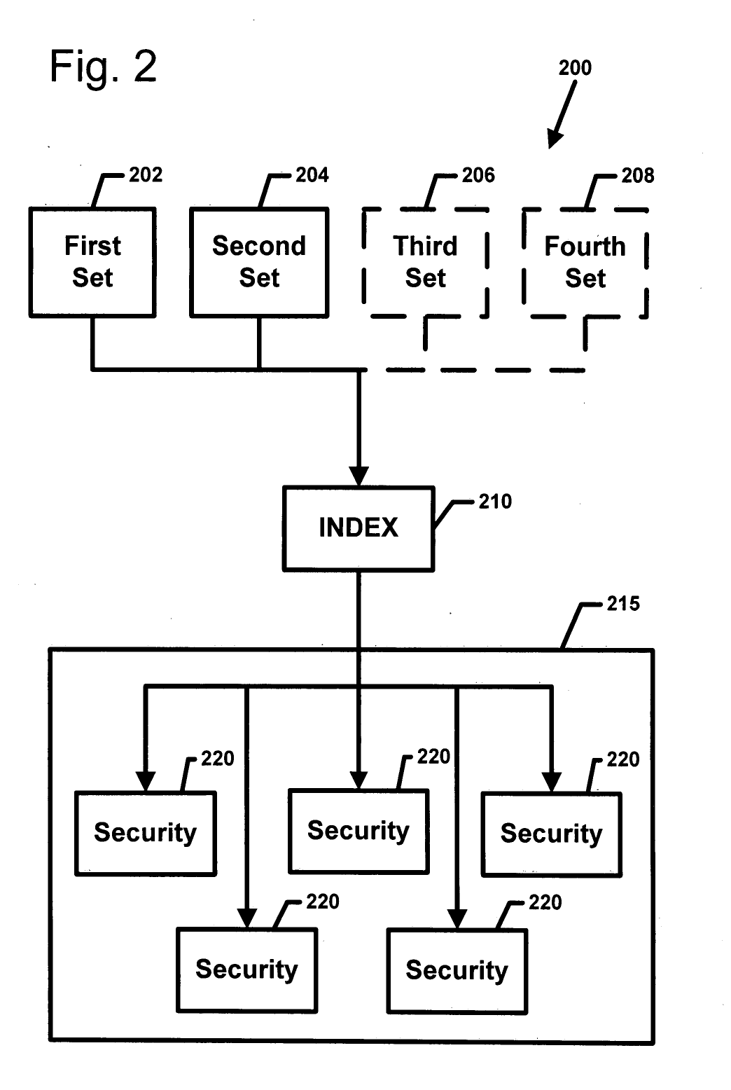

Referring now to FIG. 2, the present disclosure relates to an investment system 200 having features which are examples of inventive aspects in accordance with the principles of the present disclosure. The investment system 200 includes at least two asset groups 202, 204 forming constituents of an index 210 from which an exchange traded fund 215 or other investment product can be formed. The index 210 can be composed of multiple asset groups. In the example embodiment shown in FIG. 2, the index lists four asset groups 202, 204, 206, 208.

In some example embodiments, the index 210 is formed from at least two asset groups 202, 204. In one example embodiment, the index 210 is composed of securities selected to represent the relative strength of a regional economic market by combining the economic market strengths of different localities within the region. Each asset group 202, 204 represents the assets of companies headquartered in a particular locality. For example, the index 200 can list assets of the largest market capitalization, publicly-traded corporations headquartered within each state of the United States of America. Of course, the index 210 also can be formed based on any number of underlying asset groups or underlying indexes.

In one example embodiment, preferably, the investment system 200 includes an investment product (e.g., a unit investment trust registered under the Investment Company Act of 1940) 215 that provides investors with the opportunity to purchase a security 220 representing a proportionate, undivided interest in a portfolio of securities designed to generally correspond to the net price and yield performance of the underlying index 210. Individual securities 220 can be listed to trade on a security exchange (e.g., a stock exchange) at prices established throughout the trading day, similar to any other equity security trading in the secondary market on an exchange.

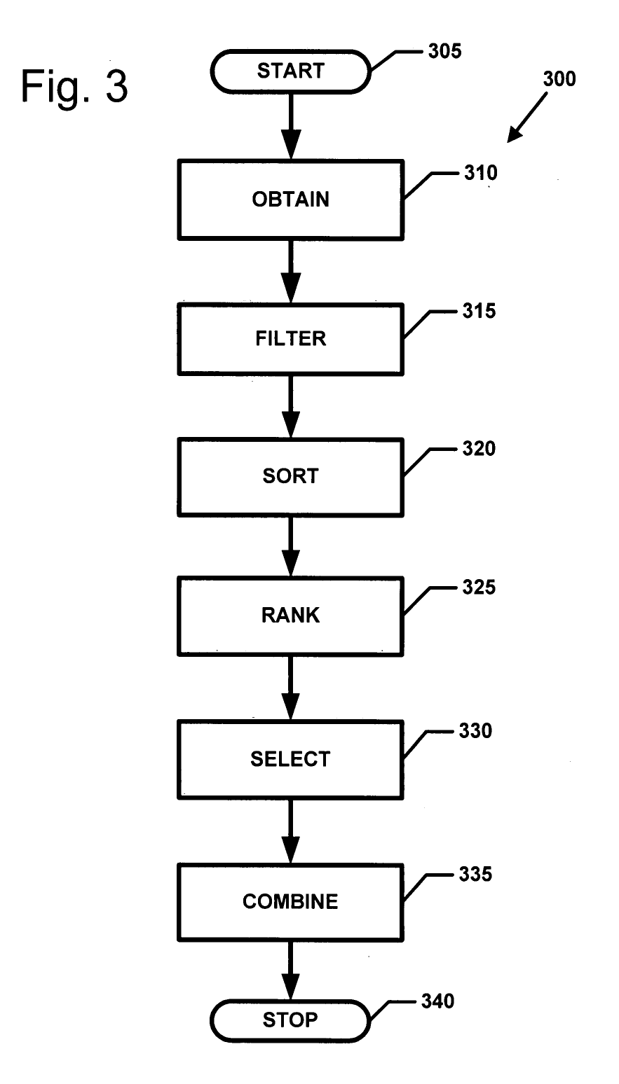

FIG. 3 illustrates an operation flow chart depicting an example creation process 300 for producing a locality-based index, such as the index 210 shown in FIG. 2. The creation process 300 initializes and begins at a start module 305 and proceeds to an obtain operation 310.

The obtain operation 310 acquires one or more lists of securities from which select securities will be chosen for inclusion in the index. Each security is associated with a company. Typically, each company is associated with only one type of security (e.g., a specific class of stocks). If a company is associated with multiple types of securities, than one of the securities is chosen and represented in the list. For example, in an embodiment, a company can be represented by its most liquid class of stocks.

In an example embodiment, the obtain operation 310 obtains a list of securities associated with companies domiciled in a given region. In another embodiment, the obtain operation 310 acquires a list of securities of companies regardless of the place of domicile. Of course, alternatively, the obtain operation 310 can receive lists of companies rather than lists of the securities of the companies.

The creation process 300 analyzes and processes the list(s) of securities acquired in the obtain operation 310 in subsequent operations 315, 320, 325. While an example sequence for these operations is provided in FIG. 3, the disclosure is not so limited and these subsequent operations 315, 320, 325 can be performed in any desired order.

A filter operation 315 eliminates securities from the list(s) based on eligibility criteria. For example, in an embodiment, securities of holding companies and partnerships are removed from the list(s). In other embodiments, the filter operation 315 eliminates closed ended funds, securities of holding companies, tracking stocks, securities of limited partnerships, securities of master limited partnerships investment vehicles, exchange-traded funds, ADR, ADS, MLP IT units, and/or royalty trusts.

The filter operation 315 also can analyze the liquidity of each security. For example, in an embodiment, the filter operation 315 can exclude companies having a ratio of annular dollar value to market capitalization of less than a predetermined amount. In an example embodiment, the filter operation 315 excludes companies having a ratio of less than 0.03%.

A sort operation 320 divides the securities based on the locality with which the respective company is associated. For example, in an embodiment, the securities each can be divided based on their respective company's place of incorporation. In another embodiment, the securities each can be divided based on the locality in which each of their respective companies is headquartered. In an example embodiment, the sort operation 320 divides the securities into fifty lists with each list including securities from one of the fifty states of the United States of America.

A rank operation 325 applies predetermined selection criteria to the securities to rank the securities in a hierarchy. For example, in an embodiment, the rank operation 325 ranks the companies by total market capitalization from largest to smallest. In other embodiments, the rank operation 325 ranks the companies based on revenue, earnings, profit margin, earnings per share, sales, dividends, date a company incorporated, the Alpha of the security, and/or the Beta coefficient of the security.

A selection operation 330 determines the top securities of each sorted list and a combine operation 335 forms the index with the top securities. For example, in an embodiment, the selection operation 330 determines the top ten securities within each sorted list based on the selection criteria. The combine operation 335 creates an index having these top ten securities from each locality as components. The creation process 300 completes and ends at a stop module 340.

In different embodiments, the selection operation 330 and combine operation 335 can utilize a different number of securities. For example, in an embodiment, the section operation 330 can determine the top two securities from each locality. In another embodiment, the section operation 330 can determine the top fifty securities from each locality. In yet another embodiment, the section operation 330 can determine the top one-hundred (100) securities from each locality.

In an example embodiment, the combine operation 335 assigns the same investment percentage to each constituent in the index. For example, in an index formed by combining the ten largest companies by market capitalization in each of the fifty states, each constituent of the index would have an investment percentage of 0.20. The weight can be rebalanced periodically to keep the weight substantially equal. In another example embodiment, if the index described above does not include 500 constituents due to lack of eligible companies, then a weight divisor is adjusted accordingly when rebalancing the index.

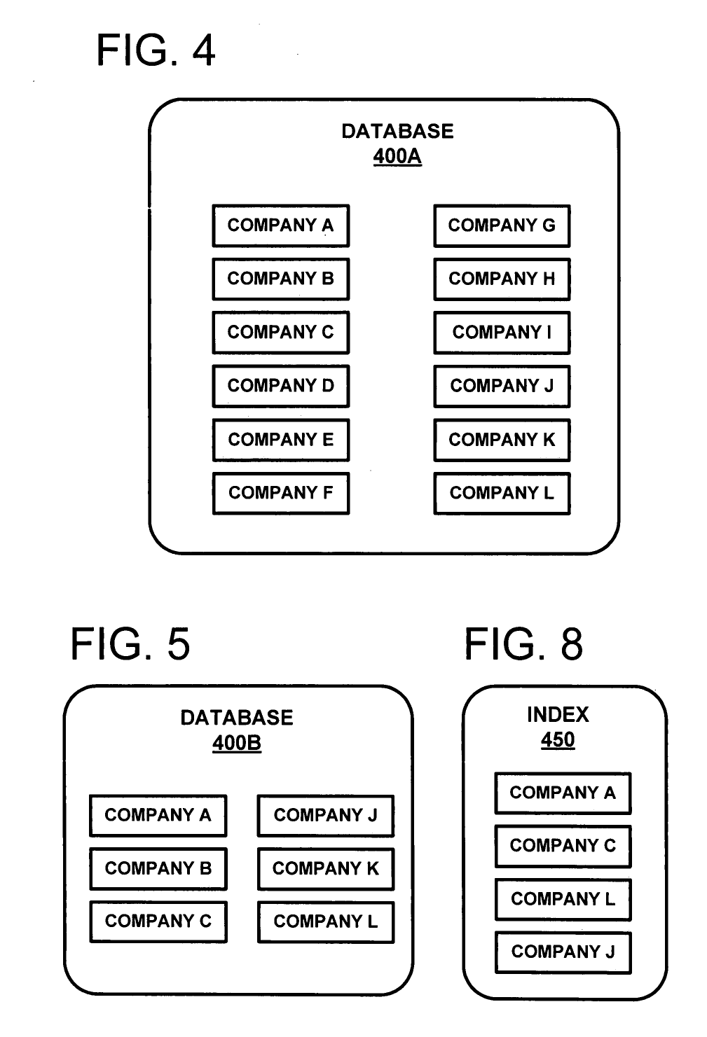

Referring to FIGS. 4-7, the teachings of the present disclosure can best be understood through the description of an example application. In an example embodiment, an index is created by populating a database with identities of companies, the locality in which each company is headquartered, and information about each company (e.g., market capitalization) related to selection criteria.

This information can be manipulated using the operations of creation process 300 shown in FIG. 3. FIGS. 4-7 illustrate changes in the arrangement of information stored within a database 400. FIG. 4 shows the results from performing the obtain operation 310 of FIG. 3 in accordance with an embodiment of the disclosure. In particular, FIG. 4 shows the database 400A containing a list of companies A-L having securities. In an example embodiment, the database 400A includes all of the publicly traded companies in one or more geographic regions. Information pertaining to each company A-L is not expressly shown, but will be understood to be included.

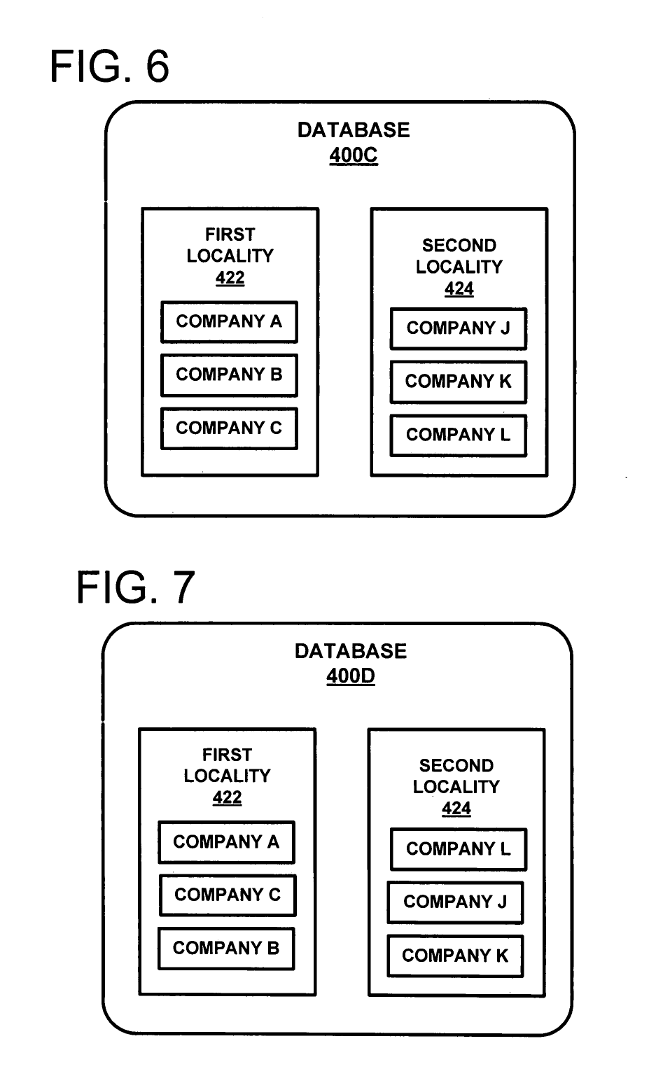

The results of the filter operation 315 are shown in FIG. 5. In the embodiment shown, securities D-I did not meet the eligibility requirements and so have been eliminated from the listing stored in database 400B. The sort operation 320 results in the database arrangement 400C shown in FIG. 6. The securities stored in database 400 shown in FIG. 6 have been arranged into lists 422, 424 by locality. In the example shown, companies A-C are headquartered in a first locality and companies J-L are headquartered in a second locality.

The results of the rank operation 325 are shown in database arrangement 400D of FIG. 7. The database arrangement 400D includes the first list 422 of securities headquartered at the first locality and the second list 424 of securities headquartered at the second locality. The companies of each list 422, 424 have been ranked according to selection criteria.

For example, the companies can have been ranked according to total market capitalization. In the example shown, company A has a larger market capitalization than company C, which has a larger market capitalization than company B. Company L has a larger market capitalization than company J, which has a larger market capitalization than company K. Of course, other selection criteria also can be used.

A predetermined number of top ranked companies from each locality are selected and combined to form the index. FIG. 8 shows the index 450 resulting from execution of the select operation 330 and the combine operation 335 in accordance with an embodiment of the disclosure. In the example shown, the index 450 includes a combination of the top two companies A, C, L, and J selected from each sorted list 422, 424.

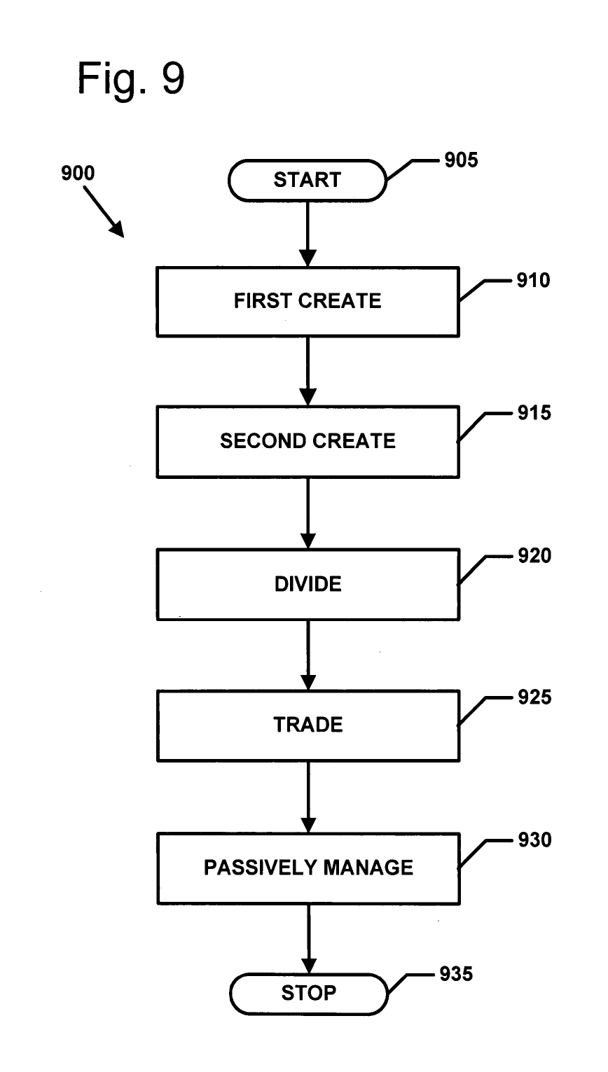

FIG. 9 illustrates an operation flow chart depicting an example process 900 for creating and trading an investment product (e.g., an exchange-traded fund) on a security exchange. The process 900 begins at operation 905 and proceeds to create operation 910. The first create operation 910 forms an underlying index on which the investment product will be based. In an example embodiment, the create operation 910 forms the index using the creation process 300 from FIG. 3.

A second create operation 915 produces an investment product based on the index. For example, the second create operation 915 can create an exchange traded fund (ETF) based on the index. An Exchange Traded Fund (“ETF”) is a security that includes multiple stocks, similar to a mutual fund, but trades on a stock exchange like an ordinary stock. In an embodiment, the ETF is formed by obtaining securities from each company listed in the index.

A produce operation 920 divides the investment product into tradable units (e.g., shares). Each share represents an undivided ownership interest in the investment product. An exchange operation 925 trades the shares of the investment product on a security exchange. For example, shares of an ETF can be bought and sold on a security exchange, such as the New York Stock Exchange, AMEX, the NASDAQ, the national market, and the NASDAQ small cap.

A manage operation 925 passively manages the index. For example, the manage operation 925 can delete, add, and/or substitute companies within the index due to changes in eligibility and/or rank. Preferably, securities are added to and deleted from the index on a non-discretionary, automatic basis when external events occur. Component weighting of the index also can be determined and adjusted on a non-discretionary basis. In an example embodiment, the manage operation 925 determines whether changes should be made to the composition as needed and rebalances the weighting of the index on a quarterly-basis.

Additional details regarding the formation of one type of exchange traded fund can be found in application Ser. No. 11/269,404, filed Nov. 7, 2005, and entitled “EXCHANGE TRADED FUND FORMED FROM AT LEAST TWO UNDERLYING INDEXES,” the disclosure of which is incorporated by reference herein.

In general, a value of the index can be calculated as the quotient of the Index Market Value and an Index Divisor.
Index Value=[Index Market Value/Index Divisor] (1) The Index Market Value is the aggregate of the value of each constituent in the index.

$$Index Market Value = {\sum }_{i = 1}^{N} {( IndexShares )}_{i} \times {( Price )}_{i} \qquad ( 2 )$$

where N is equal to the number of constituents of the index.

At the beginning of each rebalancing period, Index Shares are set to substantially equalize the weighting across the index. For example, in an embodiment in which the index has 500 constituents, the Index Shares can be set so that each constituent has a weight of 20 base points. The Index Share of each constituent is calculated using the equation below:

$$IndexShares ( after rebalance ) = \frac{Weight \times {\sum }_{i = 1}^{N} {( Price )}_{i}}{{( Price )}_{i}} \qquad ( 3 )$$

where Price is equal to the price of the shares at the beginning of the rebalancing.

The Index Divisor also is rebalanced during each rebalancing period. In a preferred embodiment, the Index Divisor is calculated according to the equation below:
Index Divisor_{after rebalance}=Index Value_{before rebalance}×Index Market Value_{after rebalance} (4)

Continuity in index values can be maintained by adjusting the weight divisor when changes (e.g., additions, deletions, rights issued, share buyback, issuances, and spin offs) are made to any of the constituents. In a preferred embodiment, the Weight is equal to about 0.02 when the index has 500 constituents. In another example embodiment, the index has 447 constituents and the weight is equal to about 0.022. In between rebalancing periods, the weight of each constituent fluctuates as market prices change.

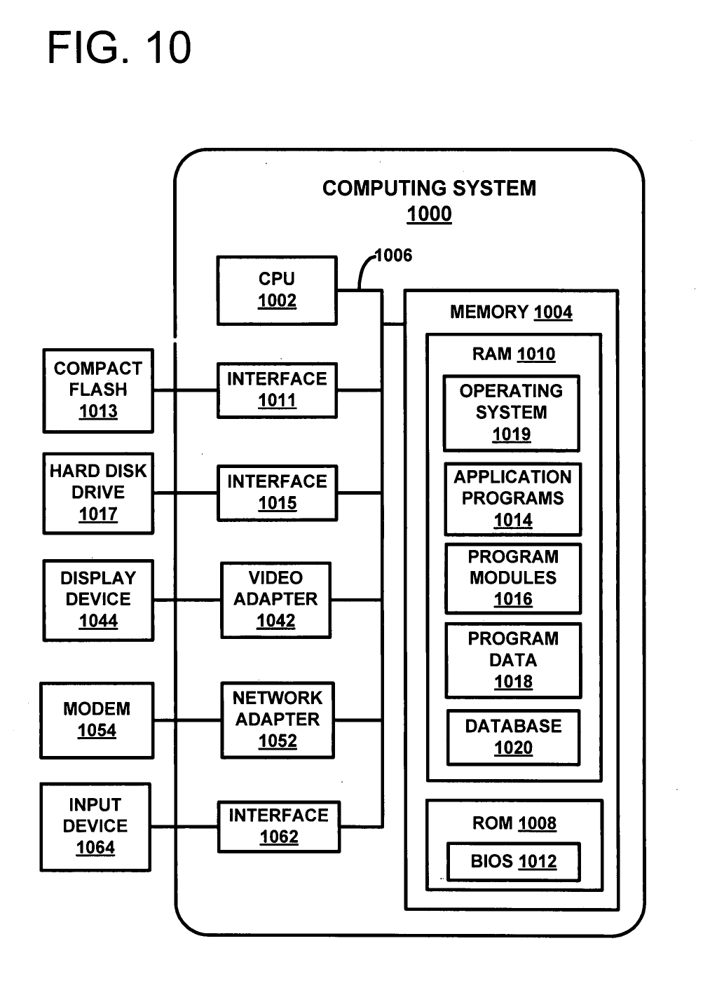

Referring now to FIG. 10 an exemplary environment for implementing embodiments of the present disclosure includes a general purpose computing device in the form of a computing system 1000, including at least one processing unit (e.g., a CPU) 1002. Different types of processing units 1002 are available from a variety of manufacturers, for example, Intel® or Advanced Micro Devices®.

The computing system 1000 also includes a system memory 1004, and a system bus 1006 that couples the system components including the system memory 1004 to the processing unit 1002. The system bus 1006 might be any of several types of bus structures including a memory bus, or memory controller; a peripheral bus; and a local bus using any of a variety of bus architectures. Preferably, the system memory 1004 includes read only memory (ROM) 1008 and random access memory (RAM) 1010. A basic input/output system 1012 (BIOS), containing the basic routines that help transfer information between components within the computing system 1000, such as during start-up, is typically stored in the ROM 1008.

Preferably, the computing system 1000 further includes a secondary storage device 1017, such as a hard disk drive, for reading from and writing to a hard disk (not shown), and/or a compact flash card 1013. The hard disk drive 1017 and compact flash card 1013 are connected to the system bus 1006 by a hard disk drive interface 1015 and a compact flash card interface 1011, respectively. The drives and cards and their associated computer-readable media provide nonvolatile storage of computer readable instructions, data structures, program modules and other data for the computing system 1000.

Although the exemplary environment described herein employs a hard disk drive 1017 and a compact flash card 1013, it should be appreciated by those skilled in the art that other types of computer-readable media, capable of storing data, can be used in the exemplary system. Examples of these other types of computer-readable mediums include magnetic cassettes, flash memory cards, digital video disks, Bernoulli cartridges, CD ROMS, DVD ROMS, random access memories (RAMs), read only memories (ROMs), and the like.

A number of program modules may be stored on the hard disk 1017, compact flash card 1013, ROM 1008, or RAM 1010. Examples of such program modules include an operating system 1019, one or more application programs 1014, other program modules 1016, and program data 1018. Databases 1020 also can be stored on the memory 1004 and external media.

A user may enter commands and information into the computing system 1000 through an input device 1064. Examples of input devices might include a keyboard, mouse, microphone, joystick, game pad, satellite dish, scanner, digital camera, touch screen, and a telephone. These and other input devices are often connected to the processing unit 1002 through an interface 1062 that is coupled to the system bus 1006. These input devices also might be connected by any number of interfaces, such as a parallel port, serial port, game port, or a universal serial bus (USB).

A display device 1044, such as a monitor or touch screen LCD panel, is also connected to the system bus 1006 via an interface, such as a video adapter 1042. The display device 1044 might be internal or external. In addition to the display device 1044, computing systems, in general, typically include other peripheral devices (not shown), such as speakers, printers, and palm devices.

When used in a LAN networking environment, the computing system 1000 is connected to the local network through a network interface or adapter 1052. When used in a WAN networking environment, such as the Internet, the computing system 1000 typically includes a modem 1054 or other means, such as a direct connection, for establishing communications over the wide area network. The modem 1054, which can be internal or external, is connected to the system bus 1006 via the interface 1052. In a networked environment, program modules depicted relative to the computing system 1000, or portions thereof, may be stored in a remote memory storage device. It will be appreciated that the network connections shown are exemplary and other means of establishing a communications link between the computing systems may be used.

A computing device, such as computing system 1000, typically includes at least some form of computer-readable media. Computer readable media can be any available media that can be accessed by the computing system 1000. By way of example, and not limitation, computer-readable media might comprise computer storage media and communication media.

Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium that can be used to store the desired information and that can be accessed by the computing system 200.

Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared, and other wireless media. Combinations of any of the above should also be included within the scope of computer-readable media. Computer-readable media may also be referred to as computer program product.

The above specification, examples and data provide a complete description of the manufacture and use of the composition of the invention. Since many embodiments of the invention can be made without departing from the spirit and scope of the invention, the invention resides in the claims hereinafter appended.

We claim:

1. A method of forming an index, the method comprising:
obtaining at least a first list of securities, each security being associated with a company, each company being associated in one of a plurality of localities;
sorting the securities of the first list into a plurality of sorted lists based on the locality in which the respective company is associated, each sorted list being associated with one of the localities;
ranking the securities of each of the sorted lists into a hierarchy based on selection criteria;
identifying a predetermined number of securities ranked at a top of the hierarchy of each sorted list;
selecting the identified securities from each of the sorted lists; and
combining the identified securities into an index.

2. The method of claim 1, further comprising eliminating securities from the first list based on eligibility criteria.

3. The method of claim 2, wherein eliminating securities from the first list comprises eliminating at least one of the group consisting of securities of holding companies, tracking stocks, securities of limited partnerships, securities of master limited partnerships investment vehicles, exchange-traded funds, ADR, ADS, MLP IT units, and royalty trusts.

4. The method of claim 1, wherein obtaining at least a first list of securities comprises retrieving the securities from a database stored in memory on a computing system.

5. The method of claim 1, wherein sorting the securities of the first list comprises sorting the securities of the first list based on the locality in which the respective company is headquartered.

6. The method of claim 1, wherein ranking the securities of each of the sorted lists comprises ranking the securities of each sorted list from largest to smallest based on total market capitalization.

7. The method of claim 6, identifying a predetermined number of securities ranked at a top of the hierarchy of each sorted list comprises identifying a predetermined number of the largest securities of each sorted list based on market capitalization.

8. The method of claim 7, identifying a predetermined number of securities ranked at a top of the hierarchy of each sorted list comprises identifying the ten largest securities of each sorted list based on market capitalization.

9. The method of claim 1, wherein ranking the securities of each of the sorted lists comprises ranking the securities of each sorted list based on at least one of the group consisting of revenue, earnings, profit margin, earnings per share, sales, dividends paid, a date of incorporation, an Alpha of the security, and a Beta coefficient of the security.

10. The method of claim 1, wherein combining the identified securities into an index comprises balancing the securities on an equal weight basis.

11. The method of claim 1, further comprising managing the index including:
periodically ranking the securities; and
substituting a new security for an old one of the securities combined in the index when the new security outranks the old security.

12. The method of claim 1, further comprising forming an investment product based on the index.

13. The method of claim 12, further comprising forming an exchange traded fund.

14. An index representing an economic market of a region, the region having a plurality of localities, each locality being associated with a plurality of companies, the index comprising:
a plurality of first securities, the first securities being associated with a first locality within the region, each of the first securities being associated with a different company in the first locality, and each of the companies associated with the first securities being ranked highly relative to the remaining companies in the first locality based on selection criteria; and
a plurality of second securities, the second securities being associated with a second locality within the region, each of the second securities being associated with a different company in the second locality, and each of the companies associated with the second securities being ranked highly relative to the remaining companies in the second locality based on the selection criteria.

15. The index of claim 14, wherein the index is an equal-weight index.

16. The index of claim 14, wherein the region includes a country and wherein each locality includes a political region within the country.

17. The index of claim 16, wherein the region includes the United States of America, which has fifty states, and wherein each locality includes a different one of fifty states.

18. The index of claim 14, wherein the region includes a continent and wherein each locality includes a country within the continent.

19. The index of claim 14, wherein the selection criteria includes total market capitalization.

20. A method comprising:
obtaining a first set of publicly traded companies within America, which as fifty states;
determining in which state each of the publicly traded companies of the first set is headquartered;
sorting the publicly traded companies into a plurality of second sets according to the state in which each company is headquartered;
determining a market capitalization of each of the publicly traded companies within each of the second sets;
ranking the publicly traded companies within each of the second sets from largest market capitalization to smallest market capitalization;
determining a third set of ten publicly traded companies within each of the second sets, the ten publicly traded companies of the third ranking highest based on market capitalization; and
combining the ten publicly traded companies of each of the third sets into an index.
